(19) United States
(12) Patent Application Publication
(10) Pub. No.: US 2026/0277582 A1
(43) Pub. Date: Sep. 17, 2026

(54) DEVICE SELF-MANAGEMENT OF FIRMWARE AND CONFIGURATION

(71) Applicant: Landis+Gyr Technology, Inc., Alpharetta, GA (US)

(72) Inventors: David STENBERG, Lafayette, IN (US); Justin MATTHEWS, Sydney, NSW (AU); Frank J. BOUDREAU, JR., Lafayette, IN (US)

(21) Appl. No.: 19/168,052

(22) PCT Filed: Mar. 18, 2024
(86) PCT No.: PCT/US2024/020382

§ 371 Date: Sep. 23, 2025

(30) Foreign Application Priority Data
Mar. 24, 2023 (GB) 2304372.2

(51) Int. Cl. G06F 8/61

(52) U.S. Cl. CPC G06F 8/63

(57) ABSTRACT

A method of programming a metering device with firmware comprising: assembling the metering device, wherein the metering device comprises a memory and a processor executable to initiate programming of the metering device with the firmware, writing, to the memory, a firmware database comprising a plurality of firmware images, each of the plurality of firmware images comprising a different firmware version and/or different configuration settings, receiving an input indicating which one of the plurality of firmware images from the firmware database should be used to operate the metering device, and initiating, by the processor, when the metering device is connected to a power source and in response to the received input, operation of the metering device using the indicated one of the plurality of firmware images from the firmware database.

### TECHNICAL FIELD

The invention relates to a method of programming a metering device with firmware.

### BACKGROUND

Metering devices, such as electric meters, gas meters, water meters etc., include firmware and/or programmable configuration settings that control the operation of the metering device. Metering devices may be programmed using firmware images. Firmware images may comprise one or more of a programme, an operating system, device drivers and/or other software that the device needs to operate and/or perform its in use functions. During manufacture, metering devices may be programmed by writing a firmware image to the memory of a microprocessor of the metering device.

Programming may occur throughout the manufacturing process, for example, chips may be directly programmed before being placed on a Printed Circuit Board (PCB), programming may occur once the PCB has been assembled, i.e. at the Printed Circuit Board Assembly (PCBA) level, and/or programming may occur once the metering device has been fully assembled, for example using optical, wired or Radio Frequency (RF) communications. Typically, a metering device may be programmed and reprogrammed a number of times during manufacture. For example, an initial testing firmware image may be programmed to the metering device to facilitate testing of the device. The metering device may later be reprogrammed with a new firmware image one or more times during manufacture before being shipped to a customer/end user with a final firmware image such that the metering device is appropriate for use by the customer/end user. The final firmware image programmed onto the metering device will depend on the customer/end user, since not all customers will utilise the same version of firmware, and some customers may require customised configuration settings.

In current manufacturing processes, to programme the metering device, typically, a PCBA comprising a processor and memory is placed in a fixture (such as a bed of nails fixture/tester) that uses an external programming device to programme the processor.

This process can take around 30 seconds per metering device, and requires a dedicated step in the manufacturing process, therefore adding to the manufacturing time required to produce a metering device and requiring the PCBAs to be segregated and inventoried based on the applied firmware version. This problem is exacerbated when producing metering devices in large volumes. Furthermore, each external programming device needs to be validated to ensure the relevant firmware image is correctly programmed thereon.

There exists a need to more quickly and efficiently programme metering devices with the correct firmware.

### SUMMARY

According to the invention in a first aspect, there is provided a method of programming a metering device with firmware, the method comprising: assembling the metering device, the metering device comprising a memory and a processor executable to initiate programming of the metering device with the firmware, writing, to the memory, a firmware database comprising a plurality of firmware images, each of the plurality of firmware images comprising a different firmware version and/or different configuration settings; receiving an input indicating which one of the plurality of firmware images from the firmware database should be used to operate the metering device; and initiating, by the processor, when the metering device is connected to a power source and in response to the received input, operation of the metering device using the indicated one of the plurality of firmware images from the firmware database.

Optionally, the method further comprises dividing, by the processor, the memory into a plurality of slots, each slot accommodating one of the plurality of firmware images, and operating the metering device using a first firmware image stored in a first slot by default.

Optionally, the received input indicates that a second firmware image stored in a second slot of the memory should be used to operate the metering device, and wherein in response to the input, the processor initiates operation of the metering device using the second firmware image.

Optionally, the firmware database is written to the memory during assembly of the metering device.

Optionally, the metering device comprises a metrology module configured to collect and manage data relating to a utility to be monitored by the metering device in use, and wherein the metrology module comprises the processor and the memory.

Optionally, the metering device further comprises an edge device, the edge device comprising the memory and the processor, and a metrology module configured to collect and manage data relating to a utility to be monitored by the metering device in use, the metrology module comprising a metrology module memory, and the method further comprises: copying, in response to the input, the indicated one of the plurality of firmware images from the memory of the edge device and to the metrology module memory, such that the one of the plurality of firmware images is programmed to the metrology module memory; and initiating operation of the metering device using the one of the plurality of firmware images stored in the metrology module memory.

Optionally, the assembled metering device further comprises a communications device configured to receive and transmit data.

Optionally, the method further comprises: installing the assembled metering device at a desired location for the measurement of consumption of a utility by the metering device, wherein the installation comprises connecting the metering device to a network; polling, by the communications device, one or more metering devices connected to the same network as the metering device to determine the firmware image(s) programmed to the one or more metering devices; and instructing programming of the metering device with a firmware image from the firmware database corresponding to at least one of the determined firmware image(s) programmed to the one or more metering devices.

Optionally, the method further comprises determining, by the processor, whether a firmware image programmed to the one or more metering devices is present within the firmware database.

Optionally, if it is determined that the firmware image programmed to the one or more metering devices is not present within the firmware database, the method further comprises: transmitting, by the communications device and to a server, a request for the firmware image programmed to the one or more metering devices; and receiving, by the communications device and from the server, the firmware image for programming of the metering device.

### BRIEF DESCRIPTION OF THE DRAWINGS

FIG. 1 shows a schematic view of an exemplary metering device;

FIG. 2 shows a flowchart outlining an exemplary method of programming a metering device with a firmware image;

FIG. 3 shows a schematic view of an exemplary metering device;

FIG. 4 shows a flowchart outlining an exemplary method of programming a metering device with a firmware image;

FIG. 5 shows a schematic view of an exemplary utility metering system; and

FIG. 6 shows a flowchart outlining an exemplary method of programming a metering device with a firmware image.

### DETAILED DESCRIPTION

Disclosed herein is a method of programming a metering device with a firmware image to be used by the metering device when the metering device is installed for use by an end user. The method comprises writing, to a memory of the metering device, a firmware database comprising a plurality of firmware images. Each of the firmware images of the firmware database may be different. For example, each of the firmware images may comprise a different firmware version and/or different configuration settings. The firmware database may be written to the memory of the metering device during assembly of a printed circuit board (PCB) into a printed circuit board assembly (PCBA) of the metering device.

The method further comprises determining, by the metering device, when the device is connected to a power source, which one of the plurality of firmware images from the firmware database should be used to operate the metering device. The method may further comprise initiating, by the metering device, operation of the metering device using the determined one of the plurality of firmware images.

FIG. 1 shows an exemplary metering device 100. The metering device 100 comprises a metrology module 102 and a communications module 104. Typically, the metrology module 102 and the communications module 104 are located in/housed in the same metering device 100, but may be implemented on different circuit boards and locally connected. The skilled person will understand that in alternative implementations, the metrology module 102 and the communications module 104 may be located separately/in separate housings and connected via a wired connection, for example.

The metrology module 102 is configured to manage and collect data about a utility. For example, if the metering device is an electrical metering device, in use, the metrology module 102 is configured to manage and collect data relating to electrical power, such as data indicating electrical power consumption.

The metrology module 102 may comprise a memory 108 and a processor 110. The memory 108 may comprise a non-volatile memory and/or a volatile memory. The memory 108 may have a computer program stored therein. The computer program may comprise instructions for performing the methods disclosed herein. The computer program may be loaded in the memory 108 from a non-transitory computer readable medium, on which the computer program is stored. The metrology module 102 may further comprise measurement circuitry 112. The processor 110 is configured by the computer program to perform one or more of the functions of the measurement circuitry 112. The measurement circuitry 112 may be configured to measure the utility consumed and facilitate storing of consumption data in the memory 108.

Each of the memory 108, processor 110, and measurement circuitry 112 is in data communication with the other components 108, 110, 112 of the metrology module 102, and may be in data communication with the communications module 104 and components thereof. The metrology module 102 can be implemented as a combination of computer hardware and software. The memory 108 stores the various programs/executable files that are implemented by the processor 110, and also provides a storage unit for any required data.

The communications module 104 is configured to facilitate data communication with one or more external devices, which may comprise other metering devices, controllers, and/or a head end system/command centre.

The communications module 104 may comprise a communications device 116. The communications device 116 may comprise a receiver and transmitter, such as an antenna and/or radio or any other device that allows wired or wireless communications (for example RF communication). The communications device 116 may be in data communication with other entities, such as other metering devices, controllers, servers, and is configured to transmit and receive data accordingly.

The communications module 104 may comprise a memory 118 and a processor 120. The memory 118 may comprise a non-volatile memory and/or a volatile memory. The memory 118 may have a computer program stored therein. The computer program may comprise instructions for performing the methods disclosed herein. The computer program may be loaded in the memory 118 from a non-transitory computer readable medium, on which the computer program is stored. The processor 120 is configured by the computer program to perform one or more of the functions of the communications device 116.

As will be appreciated by the skilled person, the metering device 100 comprises firmware that controls the operation of the metering device 100. Typically, such firmware is written to a memory of the metering device 100 during manufacture/assembly of the device. As outlined above, known methods of writing firmware to a device, comprise connecting the device to a wired interface (typically this would occur at the circuit board level), such as a dedicated bed of nails fixture, and using an external programming device to write the firmware to the memory 108 of the metrology module 102 of the metering device 100 and programme the processor 110. A similar process may typically be undertaken if the firmware needs to be upgraded during the manufacturing/assembly process, that is, the metering device would be reconnected to a dedicated bed of nails fixture and an external programming device would be used to erase the previous firmware version from the memory, write the new firmware version to the memory 108 and programme the processor 110. This process adds time to the manufacturing and assembly process, which can be significant when large volumes of metering devices are being manufactured/assembled.

Once the metering device has been installed for use at a customer site, if a different or updated version of firmware is required, typically, the different/updated version of firmware is provided to the metering device by an over-the-air (OTA) download. That is, the different/updated version of firmware is transmitted wirelessly to the installed metering device for download and programming. Again, over-the-air downloads generally require significant time, and may be prone to network instability and/or network resource issues.

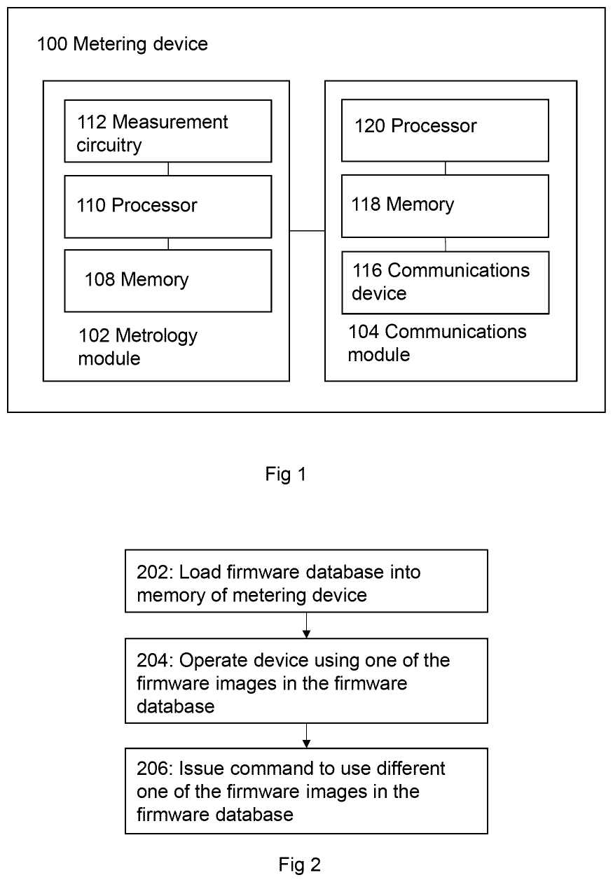

A first method for programming a metering device, such as the metering device 100, with a firmware image is described below and outlined in FIG. 2. The method described below allows firmware to be programmed and changed more quickly and efficiently than is possible using the known methods outlined above.
202: A firmware database comprising a plurality of firmware images is written to a memory of the metering device 100. Each firmware image of the plurality of firmware images comprises a different firmware version and/or different firmware and/or configuration settings.
   In this particular example, the firmware database is written to the memory 108 of the metrology module 102. However, the skilled person will appreciate that in alternative arrangements, the firmware database may be written to substantially any memory of the device with storage space available to accommodate the firmware database. For example, the metering device 100 may comprise a separate external memory, such as a memory provided by a data flash chip, and the firmware database may be written to the data flash chip memory.
   The firmware database may be written to the memory 108 of the metering device 100 during manufacture of the metering device 100.
   The firmware database may be written to the memory 108 at the circuit board level. That is, the firmware database may be written to the memory 108 before the metrology module chip is assembled on the printed circuit board, PCB, or alternatively the firmware database may be written to the memory 108 once the printed circuit board has been assembled (i.e. written to the memory 108 once a PCBA has been formed) using a fixture, such as a bed of nails fixture.
   The firmware database may comprise firmware images for operation of the metrology module 102 and/or the communications module 104. In this example, the firmware images are for operation of the metrology module 102, and so the firmware database is written to the memory 108 of the metrology module 102, however the skilled person will appreciate that a similar process may be applied using firmware images for the operation of the communications module 104.
204: The metering device 100 may be configured to operate using one of the firmware images in the firmware database.
   Exemplary methods comprise dividing the memory 108 into a plurality of slots. Each slot of the memory 108 comprises one of the plurality of firmware images in the firmware database. The memory 108 may be divided into the plurality of slots based on the memory space available for accommodating the firmware database and the size of each of the firmware images contained within the firmware database. For example, if there is 4 MB of storage within the memory 108 to accommodate the firmware database, and each firmware image is limited to 1 MB, the memory 108 would be divided into four slots, each slot accommodating one of the 1 MB firmware images. Exemplary methods may comprise compressing the firmware images stored in the memory 108.
   The method may further comprise programming the metering device 100 to operate using a first firmware image stored in a first slot of the plurality of slots by default.
   For example, a bootloader of the metering device 100, which may be stored in the memory 108, and comprises the first piece of code that runs when the metering device 100 is powered on, may be programmed to treat the memory 108 as divided into the plurality of slots outlined above. The bootloader is programmed to use the first firmware image contained in the first slot of the plurality of slots by default to operate the metering device 100.
206: If the final firmware image required to be used by the metering device 100 is the first firmware image, then no further action needs to be taken. The metering device 100 may be installed at a customer site to measure consumption of a utility, and will operate according to the first firmware image.
   In some arrangements however, the final firmware image required to be used by the metering device 100 may be different to the first firmware image used by the metering device 100 by default. Continuing with the above example, the final firmware image required to be used by the metering device 100 may be a firmware image contained in a slot of the memory different to the first slot.
   A command may be received by the metering device 100 to operate using a firmware image different to the first firmware image. In response to the command, the metering device may initiate an update and reboot sequence and on reboot operate using the different firmware image.
   For example, in response to the command, the bootloader code may be updated to specify that the metering device 100 should operate using a firmware image stored in a different slot of the memory 108 to the first firmware image stored in the first slot of the memory 108, for example a second firmware image stored in a second slot of the memory 108. The metering device 100 may be controlled to reboot in response to the bootloader update, and on reboot, the metering device 100 uses the second firmware image contained in the second slot of the memory 108 to operate (as specified in the updated bootloader code).
   The command may be issued at any point during the life of the metering device 100. For example, the command may be issued during the manufacturing/assembly process, or alternatively the command may be issued once the metering device 100 is installed at a site to measure consumption of a utility. The command may be issued and received by the metering device 100 using a wired connection. For example, during manufacturing and assembly of the metering device 100, the metering device 100 may be connected to an optical interface controller to calibrate and configure the metering device 100.
   While the metering device 100 is connected to the optical interface controller, the command may be issued to the metering device 100 to operate using a firmware image different to the first firmware image. Alternatively, the command may be received by the metering device 100 wirelessly.
   This process may be repeated if a further different firmware image is desired.

Advantageously, because the plurality of firmware images are all written to the memory 108 of the metrology module 102 of the metering device 100 (or in alternative arrangements, an alternative memory of the metering device 100), a command simply needs to be issued as outlined above to instruct operation based on a different firmware image that is already stored in the memory 108. This eliminates the need for the metering device 100 to be repeatedly attached to a dedicated fixture to allow for reflashing and/or copying and reprogramming of the firmware. The metering device can therefore be more efficiently manufactured and assembled. In particular, a separate processing/manufacturing step is not required to facilitate the programming of new firmware. Rather the command may be issued for the metering device 100 to operate based on a different firmware image stored in the memory at any point at which the metering device 100 is powered on, and in parallel to another configuration/assembly step.

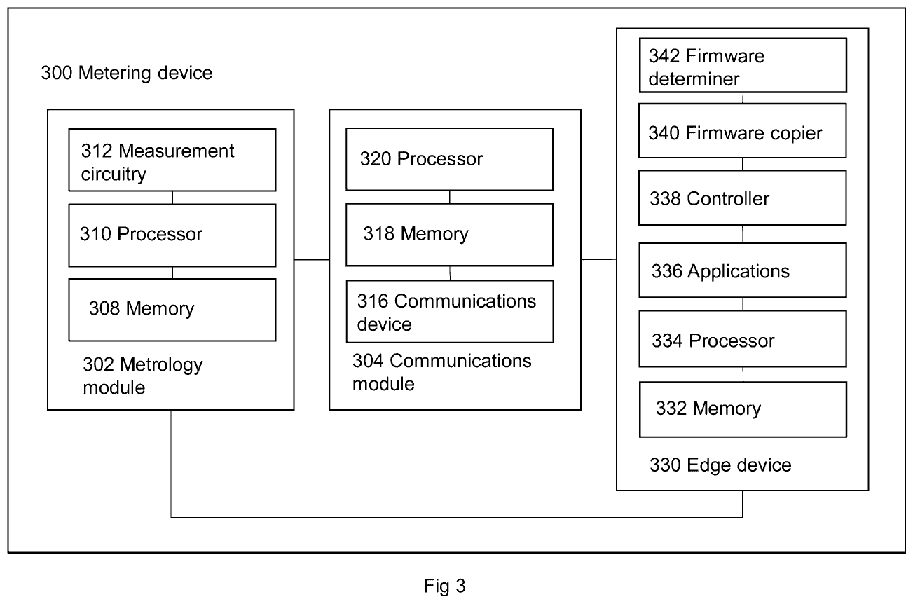

A further exemplary metering device 300 is shown in FIG. 3. The metering device 300 comprises a metrology module 302 and a communications module 304 similar to those described above in respect of the metering device 100. As such, a description of these features is not given again here and corresponding reference numerals are used to identify them in FIG. 3. Thus, 302 is the metrology module comprising a memory 308, a processor 310 and measurement circuitry 312, and 304 is the communications module comprising a communications device 316, a memory 318 and a processor 320.

The metering device 300 further comprises an edge device 330, which may be an edge intelligence device. The edge device 330 is configured to execute further functionalities, which may be implemented as individual software applications 336. For example, the edge device may facilitate monitoring, in real time, waveform data of measured currents and voltages to allow for a determination of anomalies in the waveform data, which may be indicative of power quality problems in the grid and/or issues with the connections and load.

The edge device 330 may comprise a memory 332 and a processor 334. The memory 332 may comprise a non-volatile memory and/or a volatile memory. The memory 332 may have a computer program stored therein. The computer program may comprise instructions for performing the methods disclosed herein. The computer program may be loaded in the memory 332 from a non-transitory computer readable medium, on which the computer program is stored. The edge device 330 may further comprise at least one of a plurality of applications 336 installed thereon, a controller 338, a firmware copier 340 and a firmware determiner 342. The processor 334 is configured by the computer program to perform one or more of the functions of the applications 336, the controller 338, the firmware copier 340 and the firmware determiner 342.

Each of the memory 332, the processor 334, the applications 336, the controller 338, the firmware copier 340, the firmware determiner 342 is in data communication with the other components 332, 334, 336, 338, 340, 342 of the edge device 330. The edge device 330 can be implemented as a combination of computer hardware and software. The memory 332 stores the various programs/executable files that are implemented by the processor 334, and also provides a storage unit for any required data. The edge device 330 is further in data communication with one or both of the metrology module 302 and the communications module 304, and the components thereof.

The edge device 330 is located in/housed in the same metering device 300 as the metrology module 302 and the communications module 304, but is implemented on different printed circuit board and locally connected. The skilled person will understand that in alternative implementations, the edge device 330 may be located separately/in a separate housing to one or both of the metrology module 302 and the communications module 304 and connected thereto via a wired/wireless connection, for example. The edge device 330 may further comprise a transmitter and/or receiver configured to facilitate data communication between the edge device 330 and the metrology module 304 and/or the communications module 304 and/or other entities (such as other metering devices or servers) by wireless connection, such as via WiFi communication.

Advantageously, the edge device 330 typically has a larger amount of memory available to accommodate a firmware database than the memory 308 of the metrology module 302. Furthermore, the processor 334 of the edge device 330 is typically faster than the processor 310 of the metrology module 302. Therefore, for metering devices comprising edge devices, such as the metering device 300, the firmware database may be advantageously stored in the memory 332 of the edge device 330, and the relevant firmware image may be copied to the memory 308 of the metrology module 302 for programming as desired.

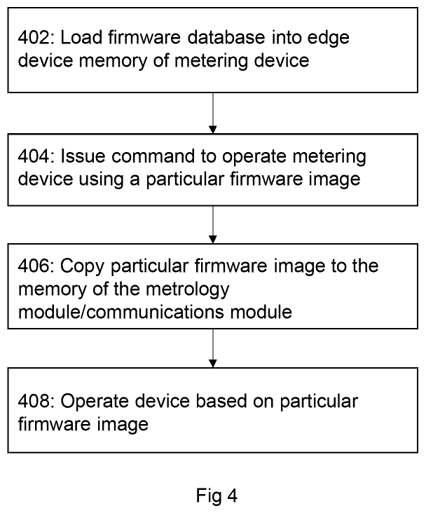

A further method for programming a metering device, such as the metering device 300, with a firmware image is described below and outlined in FIG. 4.
402: A firmware database comprising a plurality of firmware images, similar to that described above in respect of metering device 100, is written to a memory of the metering device 300. Each of the plurality of firmware images contained in the firmware database comprise a different firmware version and/or different firmware and/or configuration settings.
   In this particular example, the firmware database is written to the memory 332 of the edge device 330. As mentioned above, typically the memory 332 of the edge device 330 comprises a larger amount of storage space available to accommodate the firmware database.
   The firmware database may be written to the memory 332 of the metering device 300 during manufacture of the metering device 300. The firmware database may be written to the memory 332 of the metering device 100 using a fixture, such as a bed of nails fixture. Alternatively, the firmware database may be written to the memory 330 using a wireless connection, such as a WiFi connection, using the communications device 316.
   The firmware database may be written to the memory 332 at the circuit board level. That is, the firmware database may be written to the memory 332 before the edge device 330 is assembled on the printed circuit board, PCB, or alternatively the firmware database may be written to the memory 332 once the printed circuit board accommodating the edge device 330 has been assembled (i.e. written to the memory 332 once a PCBA has been formed), in a similar manner to as outlined above in method step 202 in respect of metering device 100.
   The firmware database may comprise firmware images for operation of the metrology module 302 and/or firmware images for operation of the communications module 304.
404. A command is sent to the metering device 300 indicating which one of the plurality of firmware images stored in the firmware database in the memory 332 of the edge device 330 should be programmed to the memory 308 of the metrology module 302.
   In some methods, in which the firmware database comprises firmware images for the operation of both the metrology module 302 and the communications module 304, the command may indicate which one of the plurality of firmware images should be programmed to the memory 318 of the communications module 304 and/or an indication of which one of the plurality of firmware images should be programmed to the memory 308 of the metrology module 302.
   The command may be received by the metering device 300 using a wired connection, or using wireless data communication, as outlined above.
406: In response to the command, the edge device 330 facilitates copying of the one of the plurality of firmware images indicated within the command, to the memory indicated within the command (i.e. the memory 308 of the metrology module 302 or the memory 318 of the communications module 304). Specifically, in response to the received command, the controller 338 of the edge device 330 controls the firmware copier 340 to copy the indicated one of the plurality of firmware images to the indicated memory.
   If the command indicates that a first firmware image in the firmware database should be programmed to the memory 308 of the metrology module 302, and a second firmware image of the firmware database should be programmed to the memory 318 of the communications module 304, the controller 338 controls the firmware copier 340 to copy the first firmware image to the memory 308 of the metrology module 302, and copy the second firmware image to the memory 318 of the communications module 304.
   For the purposes of this example, it is assumed that the command indicates that the one of the plurality of firmware images should be programmed to the memory 308 of the metrology module 302, however the skilled person will appreciate that a similar process may be undertaken in respect of the communications module 302 if the command additionally or alternatively indicates that one of the plurality of firmware images should be programmed to the memory 318 of the communications module 304.
   The one of the plurality of firmware images is stored in the relevant memory, i.e. the memory 308, such that in use, the metering device 300 operates using the one of the plurality of firmware images.
   Copying of the one of the plurality of firmware images indicated within the command may comprise storing the one of the plurality of firmware images in a volatile memory of the metrology module 302. The one of the plurality of firmware images may undergo validation and/or authentication. Once the one of the plurality of firmware images has been validated and/or authenticated, the one of the plurality of firmware image is stored and programmed to the memory 308 of the metrology module 102 (which is or comprises a non-volatile memory).
408: When the metering device 300 is next powered on/used, the metering device 300 may operate using the firmware image stored in the memory 308 of the metrology module 302 and the firmware image stored in the memory 318 of the communications module 104.

Similarly to the first method disclosed herein, advantageously, because the plurality of firmware images are all written to a memory of the metering device 300 (in this case the memory 332 of the edge device 330), a command simply needs to be issued as outlined above to instruct programming of the metrology module 302 and/or the communications module 304 based on the desired firmware image. In response to this command, the desired firmware image is programmed to the relevant memory, without the need for the metering device 300 to be repeatedly attached to a dedicated fixture to allow for reflashing and/or reprogramming of the firmware. The copying of the firmware image to the relevant memory can be undertaken at any point at which the metering device 300 is connected to a power source, either during manufacturing/assembly of the metering device 300 or once the metering device 300 is installed at a site for measuring consumption of a utility.

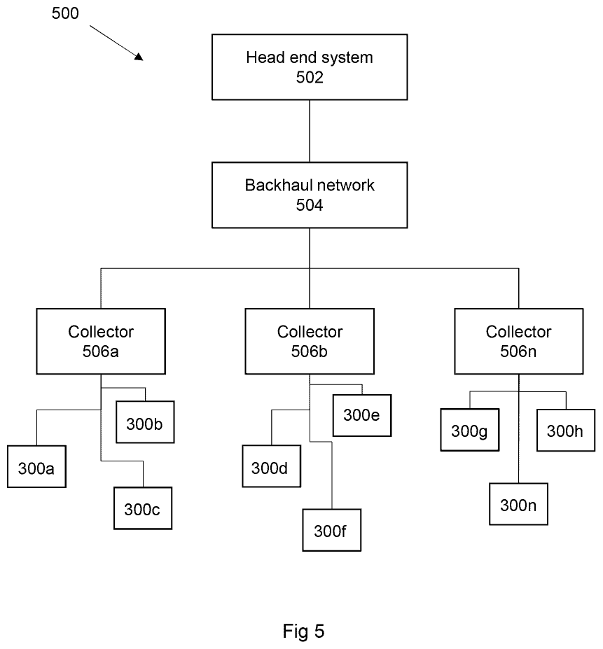

FIG. 5 shows a network topography of a typical utility metering system 500, which comprises a plurality of metering devices, which may be the metering devices 300, installed at a site to measure a utility. The utility metering system 500 comprises a head end system 502, a backhaul network 504 and a plurality of collectors 506a-n (or root nodes). Communication between the head end system 502 and the plurality of collectors 506a-n may be facilitated by the backhaul network 504. The backhaul network 104 may be a wired network (e.g. Ethernet or fibre optic cable) and/or a wireless network (e.g. a cellular network). Each collector 106a-n is in data communication with a plurality of metering devices 300a-n. In the particular example shown in FIG. 1, the collector 506a is in data communication with the metering devices 300a-c, the collector 506b is in data communication with the metering devices 300e-f and the collector 506n is in data communication with the metering devices 300g-n. The skilled person will appreciate that although FIG. 5 shows each collector 506a-n in data communication with three metering devices, this is an example only, and there may be any number of metering devices in communication with a given collector. The collectors 506a-n may aggregate the data received from the respective metering devices 300a-n and transmit the data to the head end system 502 (for example for billing purposes). The collectors 506a-n may be personal area network (PAN) coordinators, gateways, routers, or any other devices capable of communicating with the head end system 502.

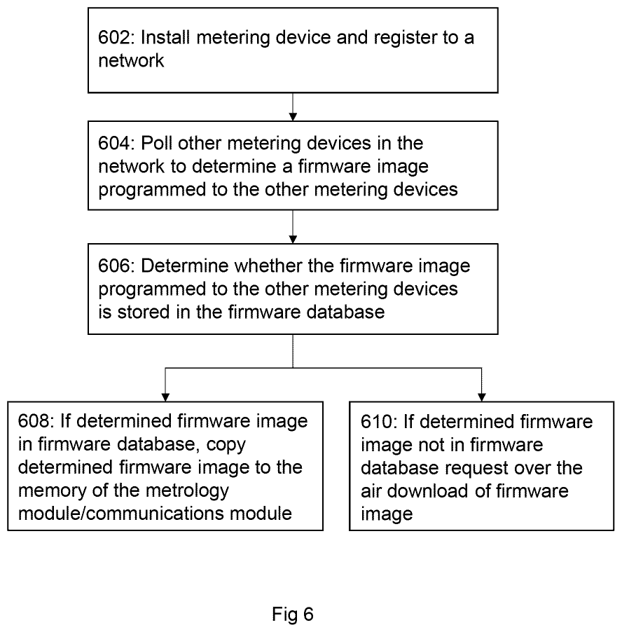

In exemplary methods, the command indicating which of the firmware images in the firmware database should be programmed to the memory 308 of the metrology module 302 or the memory 318 of the communications module 304 may be based on a poll of other metering devices connected to the same network as the metering device (e.g. the same PAN) and a determination of which firmware images are programmed to the other metering devices, as described below with reference to FIGS. 5 and 6.
602: A metering device 300c may be installed at a site for measuring consumption of a utility. On installation, the metering device 300c may undergo a registration and assignment process, and as a result be assigned to the collector 506a.
604: The metering device 300c may poll the other metering devices 300a, 300b assigned to the collector 506a to determine the firmware images programmed to the memories 308a, 308b of the metrology modules 302a, 302b of the respective metering devices 300a, 300b and/or the firmware images programmed to the memories 318a, 318b of the communication modules 304a, 304b of the respective metering devices 300a, 300b. In alternative methods, the metering device 300c may poll other metering devices located within a threshold geographical area, or all metering devices comprising a common customer ID, and/or may poll other metering devices based on other criteria, and need not be limited to polling only those metering devices assigned to a common collector.
   Polling the metering devices 300a, 300b may comprise the controller 338c of the metering device 300c controlling the communications module 304c to transmit a query to the metering devices 300a, 300b comprising a request for data indicating which firmware image is programmed to the respective memories 308a, 308b and/or 318a, 318b of the metering devices 300a, 300b.
606: In response to the query, the communications module 300c receives from the metering devices 300a, 300b, the data indicating which firmware image is programmed to the respective memories 308a, 308b and/or 318a, 318b of the metering devices 300a, 300b.
   The firmware determiner 342c may determine, based on the data received from the metering devices 300a, 300b, whether the firmware image(s) programmed to the respective memories 308a, 308b and/or 318a, 318b of the metering devices 300a, 300b are stored within the firmware database of the metering device 300c. For example, the data received from the metering devices 300a, 300b may comprise a firmware ID, or firmware version number, and the firmware determiner 342c may compare the received firmware IDs/firmware version numbers of the metering devices 300a, 300b to the firmware IDs/version numbers associated with the plurality of firmware images stored in the firmware database of the metering device 300c. Based on the comparison, the firmware determiner 342c determines whether a firmware image comprising a matching firmware ID or firmware version number is contained within the firmware database. If a matching firmware image is identified, the firmware determiner 342c determines that the matching firmware image should be programmed to the memory 308c of the metrology module 302c and/or the memory 318c of the communications module 304c.
   If the data received from the metering devices 300a, 300b indicates that each of the metering devices 300a, 300b comprises a different firmware image, the firmware determiner 342c may determine which firmware image is the most recent (i.e. the newest firmware version, or the firmware image that was programmed to the respective metering device the most recently). If a firmware image corresponding to the most recent firmware version is stored in the firmware database, the firmware determiner 342c determines that that the most recent firmware version should be programmed to the memory 306c and/or the memory 318c of the metering device 300c.
   Optionally, if the most recent firmware version is not stored within the firmware database, the firmware determiner 342c may determine the next most recent firmware version from the data received from the metering devices 300a, 300b, and determine whether the next most recent firmware version is stored in the firmware database. If the next most recent firmware version is stored in the firmware database, the firmware determiner 342c may determine that the next most recent firmware version should be programmed to the relevant memory 306c and/or 318c of the metering device 300c.
608: Once the firmware determiner 342c has determined which of the firmware images stored in the firmware database in the memory 332c of the edge device 330c should be programmed to the memory 308c of the metrology module 302c and/or the memory 318c of the communications module 304c, the edge device 330c facilitates copying of the determined firmware image to the relevant memory 308c and/or 318c. This may occur in a similar way as indicated above in method step 406. For example, the controller 338c of the edge device 330c controls the firmware copier 340c to copy the determined firmware image to the indicated memory.
610: If the firmware determiner 342c determines, based on the data received from the metering devices 300a, 300b, that none of the firmware image(s) programmed to the respective memories 308a, 308b and/or 318a, 318b of the metering devices 300a, 300b are stored within the firmware database of the metering device 300c, the controller 338c may control the communications device 316c to transmit a request to the head end system 502 to identify which firmware version should be installed on the metering device 300c. In response to the request, the head end system 502 may identify the required firmware version and initiate an over-the-air download of the required firmware image. The request may be transmitted to the head end system 502 via the collector 506a. The transmission may be sent over a wired network (e.g. Ethernet or fibre optic cable) and/or a wireless network (e.g. a cellular network).
   A similar process may be undertaken if the firmware determiner 342c determines that the most recent firmware version used by at least one of the metering devices 300a, 300b is not stored in the firmware database of the metering device 300c. For example, the metering device 300a may operate using a more recent firmware version than the metering device 300b. If a firmware image corresponding to the firmware version stored in the memory 308a of the memory 318a of the metering device 300a is not in the firmware database of the metering device 300c, the controller 338c may control the communications device 316c to transmit a request to the head end system 502 for an over-the-air download of the firmware image stored in the memory 308a or the memory 318a of the metering device 300a. In some arrangements, this request may be sent even if a firmware image corresponding to the older firmware stored on the metering device 300b is stored in the firmware database of the metering device 300c.
   In response to the request, the required firmware image may be transmitted by the head end system 502 and received by the metering device 300c for programming to the relevant memory 308c, 318c of the metering device 300c.

When the metering device 300c is next powered on/used, the metering device 300c may operate using the firmware image stored in the memory 308c of the metrology module 302c and/or the firmware image stored in the memory 318c of the communications module 304c.

In further alternative arrangements, instead of polling other metering devices 300a, 300b, when the metering device 300c is installed at a site, the controller 338c may control the communications device 316c to transmit a request to the head end system 502 for an indication of which firmware image should be programmed to the memory 308c of the metrology module 302c and/or the memory 318c of the communications module 304c respectively. In response to the request, the communications device 316c may receive a command from the head end system 302 indicating which firmware image should be programmed to one or more of the memory 308c of the meteorology module 302c and the memory 318c of the communications module 304c. If the firmware image is stored in the firmware database, the firmware copier 340c may copy the indicated firmware image to the relevant memory, using the methods outlined above. If the firmware image is not stored in the firmware database, the head end system 502 may initiate an over-the-air download of the required firmware image to facilitate storing of the required firmware image in the relevant memory of the metering device 300c.

A computer program may be configured to provide any of the above described methods. The computer program may be provided on a computer readable medium. The computer program may be a computer program product. The product may comprise a non-transitory computer usable storage medium. The computer program product may have computer-readable program code embodied in the medium configured to perform the method. The computer program product may be configured to cause at least one processor to perform some or all of the method.

Various methods and apparatus are described herein with reference to block diagrams or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

Computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, the invention may be embodied in hardware and/or in software (including firmware, resident software, micro-code, etc.) that runs on a processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

The skilled person will be able to envisage other embodiments without departing from the scope of the appended claims.

1. A method of programming a metering device with firmware, the method comprising:
assembling the metering device, the metering device comprising a memory and a processor executable to initiate programming of the metering device with the firmware,
writing, to the memory, a firmware database comprising a plurality of firmware images, each of the plurality of firmware images comprising a different firmware version and/or different configuration settings;
receiving an input indicating which one of the plurality of firmware images from the firmware database should be used to operate the metering device; and
initiating, by the processor, when the metering device is connected to a power source and in response to the received input, operation of the metering device using the indicated one of the plurality of firmware images from the firmware database.

2. A method according to claim 1, further comprising:
dividing, by the processor, the memory into a plurality of slots, each slot accommodating one of the plurality of firmware images, and operating the metering device using a first firmware image stored in a first slot by default.

3. A method according to claim 2, wherein the received input indicates that a second firmware image stored in a second slot of the memory should be used to operate the metering device, and wherein in response to the input, the processor initiates operation of the metering device using the second firmware image.

4. A method according to claim 1, wherein the firmware database is written to the memory during assembly of the metering device.

5. A method according to claim 1, wherein the metering device comprises a metrology module configured to collect and manage data relating to a utility to be monitored by the metering device in use, and wherein the metrology module comprises the processor and the memory.

6. A method according to claim 1, wherein the metering device further comprises an edge device, the edge device comprising the memory and the processor, and a metrology module configured to collect and manage data relating to a utility to be monitored by the metering device in use, the metrology module comprising a metrology module memory, the method further comprising:
copying, in response to the input, the indicated one of the plurality of firmware images from the memory of the edge device and to the metrology module memory, such that the one of the plurality of firmware images is programmed to the metrology module memory; and
initiating operation of the metering device using the one of the plurality of firmware images stored in the metrology module memory.

7. A method according to claim 1, wherein the assembled metering device further comprises a communications device configured to receive and transmit data.

8. A method according to claim 7, wherein the method further comprises:
installing the assembled metering device at a desired location for the measurement of consumption of a utility by the metering device, wherein the installation comprises connecting the metering device to a network;
polling, by the communications device, one or more metering devices connected to the same network as the metering device to determine the firmware image(s) programmed to the one or more metering devices; and
instructing programming of the metering device with a firmware image from the firmware database corresponding to at least one of the determined firmware image(s) programmed to the one or more metering devices.

9. A method according to claim 8, further comprising determining, by the processor, whether a firmware image programmed to the one or more metering devices is present within the firmware database.

10. A method according to claim 9, wherein if it is determined that the firmware image programmed to the one or more metering devices is not present within the firmware database, the method further comprises:
transmitting, by the communications device and to a server, a request for the firmware image programmed to the one or more metering devices; and
receiving, by the communications device and from the server, the firmware image for programming of the metering device.
